(19) United States
(12) Patent Application Publication
(10) Pub. No.: US 2019/0173951 A1
(43) Pub. Date: Jun. 6, 2019

(54) VEHICLE COMMUNICATION USING PUBLISH-SUBSCRIBE MESSAGING PROTOCOL

(71) Applicant: GM GLOBAL TECHNOLOGY OPERATIONS LLC, Detroit, MI (US)

(72) Inventors: Anthony J. Sumcad, Troy, MI (US); Amar Badal, Rochester Hills, MI (US)

(21) Appl. No.: 15/829,356

(22) Filed: Dec. 1, 2017

(51) Int. Cl. H04L 29/08

(52) U.S. Cl. CPC H04L 67/12; H04L 67/2809; H04L 67/26

(57) ABSTRACT

A system and method of communicating with a vehicle through use of a publish-subscribe messaging protocol, wherein the vehicle includes a wireless communications device that is capable of carrying out data communications with a remote server or system through use of a messaging broker according to the publish-subscribe messaging protocol, the method including: establishing at least one connection with a messaging broker using the wireless communications device, wherein the connection is established using the publish-subscribe messaging protocol, and wherein each of the at least one connection is established by sending a connection request message from the vehicle to the messaging broker; obtaining vehicle information from at least one vehicle system module (VSM) of the vehicle; generating a publish message at the vehicle, wherein the publish message includes the obtained vehicle information; and sending the publish message from the vehicle to the messaging broker using the publish-subscribe messaging protocol.

### INTRODUCTION

The present invention relates to communicating information in vehicle networks using a publish-subscribe messaging model, such as Message Queue Telemetry Transport (MQTT).

Vehicles include hardware and software capable of transmitting information to remote servers and for receiving messages from remote servers. Additionally, vehicles typically include devices that permit short-range wireless communications (SRWC) as well. Many vehicles are manufactured such that the vehicle reports transactional information regarding the vehicle state, conditions, operations performed, etc., to a remote server that can store the transactional information in a database. Maintaining an endpoint-to-endpoint connection between a vehicle and a vehicle backend system during times of high vehicle usage, such as during rush hour, can strain communication resources.

### SUMMARY

According to one aspect of the invention, there is provided a method of communicating with a vehicle through use of a publish-subscribe messaging protocol, wherein the vehicle includes a wireless communications device that is capable of carrying out data communications with a remote server or system through use of a messaging broker according to the publish-subscribe messaging protocol, the method including: establishing at least one connection with a messaging broker using the wireless communications device, wherein the connection is established using the publish-subscribe messaging protocol, and wherein each of the at least one connection is established by sending a connection request message from the vehicle to the messaging broker; obtaining vehicle information from at least one vehicle system module (VSM) of the vehicle; generating a publish message at the vehicle, wherein the publish message includes the obtained vehicle information; and sending the publish message from the vehicle to the messaging broker using the publish-subscribe messaging protocol.

According to various embodiments, this method may further include any one of the following features or any technically-feasible combination of these features:
the establishing step further comprises, after sending the connection request message, receiving a connection acknowledgement message from the messaging broker, wherein the connection acknowledgement message indicates that the established connection is successful;
the connection request message includes one or more topic names of topics to which the vehicle or a vehicle system module, including the at least one VSM, is requesting a subscription;
the step of receiving a second publish message from the messaging broker, wherein at least some of the data included in the second publish message is at least partly based on information included in a third publish message that was received by the messaging broker from a client device;
the client device is a mobile device and wherein the at least some of the data included in the second publish message includes a vehicle command;
the third publish message includes a quality of service indicator that guarantees delivery of the second publish message at least once;
the messaging broker is configured to: in response to receiving the third publish message at the messaging broker from the mobile device, determine whether the third publish message specifies a topic name of a topic to which the vehicle holds a subscription; when it is determined that the third publish message specifies a topic name of a topic to which the vehicle holds a subscription, determine whether the vehicle is presently connected to the messaging broker via the established connection; and when it is determined that the vehicle is not presently connected to the messaging broker via the established connection, sending a wake up message to the vehicle;
the wake up message is received at the vehicle using a data messaging protocol other than the publish-subscribe messaging protocol and wherein the method further comprises: in response to receiving the wake up message from the message broker, re-establishing the connection with the messaging broker so as to allow the second publish message to be received at the vehicle;
the vehicle includes a plurality of vehicle system modules (VSMs) and wherein the at least one connection includes a connection for each of the plurality of VSMs, and wherein each of the plurality of VSMs establish the connection with the messaging broker using the wireless communications device included in the vehicle;
each of the connection request messages includes a client identifier that is based on or derived from an identification number of the vehicle and wherein each of the client identifiers are unique from one another;
the publish message includes a topic name, and wherein the messaging broker is configured to send at least part of the publish message to one or more client devices that are subscribed to the topic name in response to receiving the publish message; and/or
the connection establishment step further includes carrying out a Secure Sockets Layer (SSL) handshake with the messaging broker.

According to another aspect of the invention, there is provided a method of communicating with a vehicle through use of a publish-subscribe messaging protocol, wherein the vehicle includes a wireless communications device that is capable of carrying out data communications with a remote server or system through use of a messaging broker according to the publish-subscribe messaging protocol, the method including: establishing a connection with a messaging broker using the wireless communications device, wherein the connection is established using a publish-subscribe messaging protocol, and wherein the connection is established by: sending a connection request message from the vehicle to the messaging broker; and after sending the connection request message, receiving a connection acknowledgement message from the messaging broker, wherein the connection acknowledgement message indicates that the established connection is successful; obtaining vehicle information from one or more vehicle system modules (VSMs) of the vehicle; generating a publish message at the vehicle, wherein the publish message comprises metadata and a payload that includes the obtained vehicle information, and wherein the metadata includes a topic name corresponding to the vehicle and/or the obtained vehicle information; sending the publish message from the vehicle to the messaging broker using the publish-subscribe messaging protocol, wherein the messaging broker is configured to send at least part of the publish message to one or more client devices that are subscribed to the topic name that was included in the publish message; and after sending the publish message, receiving a publish acknowledgement message from the messaging broker.

According to yet another aspect of the invention, there is provided a vehicle communications system, including: (a) a vehicle backend services facility that includes: (a1) one or more servers that each include a processing device and a memory device; and (a2) one or more databases that includes vehicle information; and (b) a vehicle comprising: (b1) a wireless communications device including a processing device, a memory device, and wireless communications circuitry; (b2) a plurality of vehicle system modules (VSMs); and (b3) a communications bus that connects the wireless communications device with the plurality of VSMs; (c) wherein the wireless communications device is configured to: (c1) receive a first set of messages from the plurality of VSMs using the communications bus; and (c2) send a second set of messages to a messaging broker according to a publish-subscribe messaging protocol using the wireless communications circuitry, wherein the second set of messages are based at least partly on the first set of messages; and (d) wherein the messaging broker is configured to: (d1) receive the second set of messages from the vehicle; (d2) determine whether the vehicle backend services facility is subscribed to a topic name included in the second set of messages; and (d3) when it is determined that the vehicle backend services facility is subscribed to a topic name included in the second set of messages, send a third set of messages to the vehicle backend services, wherein the third set of messages includes vehicle information contained in the second set of messages; and (e) wherein the vehicle backend services facility includes computer instructions included on the memory device that, when executed, cause the processing device to: (e1) receive the third set of messages from the messaging broker according to the publish-subscribe messaging protocol; (e2) extract the vehicle information contained in the payload of third set of messages; and (e3) store the vehicle information into the one or more databases.

According to various embodiments, this method may further include any one of the following features or any technically-feasible combination of these features:
the wireless communications circuitry includes a cellular chipset that is capable of carrying out communications with a cellular carrier system;
the second set of messages and the third set of messages are the same;
the wireless communications device is configured to establish a connection with the messaging broker according to the publish-subscribe messaging protocol and through carrying out a Secure Sockets Layer (SSL) handshake, and wherein communications between the wireless communications device and the messaging broker are carried out using Transport Control Protocol/Internet Protocol (TCP/IP) along with SSL encryption;
the vehicle communications system further comprises the messaging broker;
the second set of messages includes a payload, wherein the wireless communications device is further configured to encrypt the payload of the second set of messages using a first encryption key, wherein the third set of messages includes the encrypted payload of the second set of messages, and wherein the vehicle backend services facility includes a second encryption key that corresponds to the first encryption key according to a common encryption key so that the vehicle backend services facility can decrypt the encrypted payload of the third set of messages that are received from the messaging broker; and/or
the publish-subscribe messaging protocol is Message Queue Telemetry Transport.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of an embodiment of a method of communicating with a vehicle through use of a subscriber-push messaging protocol; and

FIG. 3 is a diagram of an embodiment of a communicating with a vehicle through use of a subscriber-push messaging protocol.

### DETAILED DESCRIPTION

The system and method described below enables communications between a vehicle and various other devices through use of Message Queue Telemetry Transport (MQTT). MQTT technologies can be integrated into vehicle communication networks and can provide various advantages over present communication protocols utilized by the conventional vehicle communication networks. The vehicle MQTT system can be used in conjunction with a variety of client devices, such as a plurality of vehicles, smartphones, other mobile devices, servers, and/or any electronic computing device that can execute an MQTT library as a client, which will be discussed more below. Although MQTT technology is discussed throughout in the embodiments below, other publish-subscribe messaging or information sharing technologies can be used. And, as used herein, “publish-subscribe messaging” refers to those technologies or protocols that use a messaging broker for sending and receiving messages and that do not include establishing connections between client devices. And, as used herein, “MQTT” refers to all variations of MQTT, including MQTT for Sensor Networks (MQTT-SN).

For example, the messaging broker connects to various clients and, in doing so, authenticates and authorizes the various client devices so that every time a client desires to send information to another client device (e.g., vehicle to backend services facility), a new connection does not have to be carried out (or maintained), which can include authentication and authorization steps. At least according to some embodiments, by maintaining a single connection for each client device in the system, information can be communicated between client devices using the messaging broker in a way that reduces the overhead of establishing direct client to client connections, which typically includes various authentication and authorization steps.

According to the publish-subscribe messaging protocol, messages can be published to the broker and, also, clients can subscribe to certain topics (e.g., which can correlate to particular client devices, classes of client devices, certain types of information, etc., as will be explained below) with the broker. The broker sends messages to client devices based on subscription information for those client devices.

In one scenario, the methods and systems herein can be used to send, receive, and store transactional information from a plurality of vehicles. In other scenarios, the vehicle can receive control commands from a smartphone via a broker, such as an MQTT broker. In some scenarios, when a vehicle is being operated, the vehicle sends more transactional information since there is more information to report, such as vehicle location, engine operation status, other vehicle system module (VSM) status, and a variety of other information. During times when many vehicles are being driven at once, such as during rush hour, the remote servers receiving and managing the information can receive very many transactional messages from a large amount of vehicles over numerous connections and, thus, managing all of these connections, as well as this great influx of messages can be cumbersome. As discussed below, the vehicle communications system using MQTT technologies (or other publish-subscribe technologies) can implement a messaging architecture for use in vehicle communications networks that can provide for more manageable networking, which, at least in some embodiments, is due to the MQTT architecture that does not use endpoint to endpoint connections—that is, the client devices all connect to a broker device, but not to other client devices directly. By not using client to client direct connections and instead having all client devices connect to a messaging broker, less authentication/authorization steps are needed to secure communications to and from the client devices using the messaging broker.

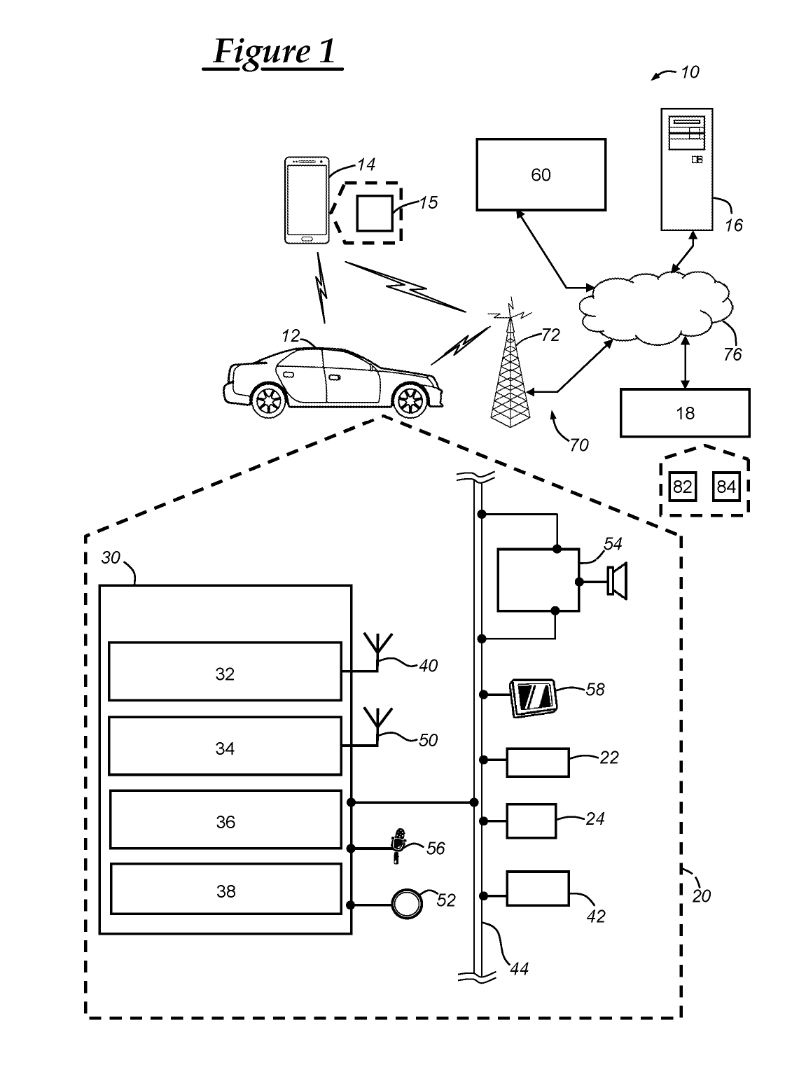

With reference to FIG. 1, there is shown an operating environment that comprises a communications system 10 and that can be used to implement the method disclosed herein. Communications system 10 generally includes a vehicle 12 with a wireless communications device 30, a mobile device 14, a remote computer 16, a remote facility 18, a messaging broker 60, one or more wireless carrier systems 70, and a land communications network 76. It should be understood that the disclosed method can be used with any number of different systems and is not specifically limited to the operating environment shown here. Also, the architecture, construction, setup, and general operation of the system 10 and its individual components are generally known in the art. For example, the communication system 10 typically includes a plurality of vehicles 12, but for reasons of simplicity, only one vehicle 12 is explicitly discussed herein. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicles 12, and/or mobile device 14). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 18. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 16 (only one shown) can be some of a number of computers accessible via a private or public network such as the Internet. As discussed in the embodiments herein, computer 16 can be a client device (e.g., an MQTT client device). As used herein, a client device is any such device that publishes and/or subscribes to messages (i.e., sends and receives using the messaging broker 60, as discussed more below) using the publish-subscribe messaging protocol. Each such computer 16 can be used for one or more purposes, such as a remote server accessible by vehicle 12. Other such accessible computers 16 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicle 12, remote facility 18, or both. A computer 16 can also be used for providing Internet connectivity such as DNS services or as a network address server that uses DHCP or other suitable protocol to assign an IP address to vehicle 12 and/or the other network devices. In one embodiment, computers 16 can be used to carry out the method discussed herein; in other embodiments, the method can be carried out by servers or other computing devices at remote facility 18, as discussed more below; and, it yet another embodiment, the method can be carried out by a combination of computers 16 and servers at remote facility 18.

Remote facility 18 can house a plurality of servers and database, which may be used to provide the vehicle electronics 20 and/or mobile device 14 with a number of different system back-end functions through use of one or more electronic servers. The remote facility 18 includes servers 82 and databases 84, which may be stored on a plurality of memory devices. Also, remote facility 18 can include one or more switches, live advisors, an automated voice response system (VRS), all of which are known in the art. Remote facility 18 may include any or all of these various components and, preferably, each of the various components are coupled to one another via a wired or wireless local area network. Remote facility 18 may receive and transmit data via a modem connected to land network 76. Data transmissions may also be conducted by wireless systems, such as IEEE 802.11x, GPRS, and the like. Those skilled in the art will appreciate that, although only one remote facility 18 and one computer 16 are depicted in the illustrated embodiment, numerous remote facilities 18 and/or computers 16 may be used.

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware programs stored in the memory (e.g., EEPROM, RAM, ROM), which enable the servers 82 to provide a wide variety of services. For instance, the at least one processor can execute programs or process data to carry out at least a part of the method discussed herein. For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices, such as for a connection with the messaging broker 60. Remote facility 18 can include a number of routers, modems, switches, or other network devices that can be used to provide networking capabilities, such as connecting with land network 76 and/or cellular carrier system 70.

Databases 84 can be stored on a plurality of memory, such as RAM, other temporary powered memory, any non-transitory computer-readable medium (e.g., EEPROM), or any other electronic computer medium that stores some or all of the software needed to carry out the various external device functions discussed herein. One or more databases at the remote facility can store account information such as subscriber authentication information, vehicle identifiers, vehicle transactional information, vehicle reservation information, car sharing information pertaining to a car sharing service of which the vehicle may be a part of, profile records, behavioral patterns, and other pertinent subscriber information. Also, a vehicle information database can be included that stores information pertaining to one or more vehicles, such as transactional information that can be obtained by a plurality of vehicles (including vehicle 12) and sent to the remote facility 18. Transactional information can include information that is obtained in response to certain vehicle events, such as turning on the ignition of the vehicle (or otherwise starting the vehicle primary propulsion system). Transactional information can include vehicle location, a timestamp (or other time indicator), a vehicle identifier (e.g., a vehicle identification number (VIN)), a vehicle operation or status, etc.

Mobile device 14 is a client device and can be any type of transportable electronic computing device having network capabilities, such as a personal mobile device including smartphones, tablets, laptops, and wearable electronic computing devices including smart-watches and smart-glasses. Mobile device 14 can include hardware, software, and/or firmware enabling cellular telecommunications and short-range wireless communications (SRWC) as well as other mobile device applications, including a client messaging application (e.g., an MQTT client application) that can be used in conjunction with the publish-subscribe messaging architecture as described herein. As used herein, a personal mobile device is a mobile device that is capable of SRWC, that is portable by a user, and where the portability of the device is at least partly dependent on the user, such as a wearable device (e.g., a smart-watch, a pair of smart-glasses), an implantable electronic computing device, or a handheld electronic computing device (e.g., a smartphone, a tablet, a laptop). As used herein, a short-range wireless communications (SRWC) device is a device capable of SRWC and that includes the requisite SRWC circuitry to perform such SRWC.

In one embodiment, all or any of the SRWC devices discussed herein, including the mobile device 14, includes a wireless network interface card (WNIC) that can utilize IEEE 802.11 protocols, as well as other wireless IEEE 802 protocols, including IEEE 802.15 and IEEE 802.16. Additionally or alternatively, mobile device can include a cellular chipset that enables the mobile device to carry out cellular communications over cellular carrier system 70. And, at least in some embodiments, mobile device 14 can include one or more antennas that can be used for wireless transmissions, including radio signal transmissions for use with other SRWC devices or for use with cellular carrier system 70.

In one particular embodiment, mobile device 14 can use a cellular chipset or a WNIC included therein to send messages to messaging broker 60 through use of a publish-subscribe messaging protocol, such as Message Queue Telemetry Transport (MQTT). The cellular chipset or WNIC of mobile device 14 can be used to send and receive messages from the messaging broker 60 through use of Transport Control Protocol/Internet Protocol (TCP/IP) technologies for addressing and transport of the messages, with a publish-subscribe messaging protocol (e.g., MQTT) used on top at the application layer. Other embodiments exist, as discussed more below.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) module 22, engine control unit (ECU) 24, a wireless communications device 30, other vehicle system modules (VSMs) 42, and numerous other components and devices. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS module 22, ECU 24, a body control module (BCM) (not shown), wireless communications device 30, and vehicle user interfaces 52-58, as will be described in detail below. The vehicle 12 can also include other VSMs 42 in the form of electronic hardware components that are located throughout the vehicle and, which may receive input from one or more sensors and use the sensed input to perform diagnostic, monitoring, control, reporting, and/or other functions. Each of the VSMs 42 is preferably connected by communications bus 44 to the other VSMs, as well as to the wireless communications device 30, and can be programmed to run vehicle system and subsystem diagnostic tests. One or more VSMs 42 may periodically or occasionally have their software or firmware updated and, in some embodiments, such vehicle updates may be over the air (OTA) updates that are received from a computer 16 or remote facility 18 via land network 76 and communications device 30. As is appreciated by those skilled in the art, the above-mentioned VSMs are only examples of some of the modules that may be used in vehicle 12, as numerous others are also possible.

Wireless communications device 30 is shown as including a SRWC circuit 32, a cellular chipset 34, a processor 36, memory 38, and antennas 40 and 50. In other embodiments, wireless communications device 30 can be any electronic computing device that is capable of sending and receiving communications from one or more networks external to the vehicle electronics 20. Wireless communications device 30 is a client device and is capable of communicating data via short-range wireless communications (SRWC) and/or via long range communications, such as through use of radio communications with cellular carrier system 70. Wireless communications device 30 can be a standalone module, or may be incorporated into other VSMs of vehicle 12, such as an infotainment unit, a center stack module (CSM), etc. In one embodiment, wireless communications device 30 may be part of a telematics unit that includes cellular chipset 34, antenna 50, and proper software enabling wireless communication device 30 to carry out cellular communications with cellular carrier system 70.

And, as depicted in the illustrated embodiment, wireless communications device 30 is an SRWC device and includes an SRWC circuit 32 enabling SRWC communications. In one embodiment, wireless communications device 30 may be a standalone module or, in other embodiments, device 30 may be incorporated or included as a part of one or more other vehicle system modules, such as a center stack module (CSM), a body control module (BCM), an infotainment module, a telematics unit, a head unit, and/or a gateway module. In some embodiments, the device 30 can be implemented as an OEM-installed (embedded) or aftermarket device that is installed in the vehicle.

Wireless communications device 30 can be configured to communicate wirelessly according to one or more wireless protocols, including short-range wireless communications (SRWC) such as any of the IEEE 802.11 protocols, Wi-Fi™, WiMAX™, ZigBee™, Wi-Fi Direct™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device. In one embodiment, all or any of the SRWC devices discussed herein, including the mobile device 14, includes a wireless network interface card (WNIC) that can utilize IEEE 802.11 protocols, as well as other wireless IEEE 802 protocols, including IEEE 802.15 and IEEE 802.16.

Wireless communications device 30 may enable vehicle 12 to be in communication with one or more remote networks (e.g., one or more networks at remote facility 18 or computers 16) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

In one particular embodiment, wireless device 30 can use cellular chipset 34 or SRWC circuit 32 (e.g., a WNIC) included therein to send messages to messaging broker 60 through use of a publish-subscribe messaging protocol, such as Message Queue Telemetry Transport (MQTT). Cellular chipset 34 and/or SRWC circuit 32 of device 30 can be used to send and receive messages from the messaging broker 60 through use of Transport Control Protocol/Internet Protocol (TCP/IP) technologies for addressing and transport of the messages, with a publish-subscribe messaging protocol (e.g., MQTT) used on top at the application layer. Other embodiments exist, as discussed more below.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may include RAM, other temporary powered memory, any non-transitory computer-readable medium (e.g., EEPROM), or any other electronic computer medium that stores some or all of the software needed to carry out the various external device functions discussed herein.

In one embodiment, the wireless communications device 30 may operate both when the vehicle is in a powered on state and when the vehicle is in a powered off state. As used herein, a “powered on state” is a state of the vehicle in which the ignition or primary propulsion system of the vehicle is powered on and, as used herein, a “powered off state” is a state of the vehicle in which the ignition or primary propulsion system of the vehicle is not powered on. The operation or state of the wireless communications device 30 may be controlled by another vehicle system module, such as by a body control module or by an infotainment module. In the powered on state, the wireless communications device 30 may always be kept “on” or supplied with power from a vehicle battery or other power source. In the powered off state, the wireless communications device 30 may be kept in a low-power mode or may be supplied power periodically so that device 30 may wake up and perform operations.

Global navigation satellite system (GNSS) module 22 receives radio signals from a constellation of GNSS satellites. From these signals, the module 22 can determine vehicle position which may enable the vehicle to determine whether it is at a known location, such as home or workplace. Moreover, GNSS module 22 can provide this location data to wireless communications device 30, which can then use this data to identify known locations, such as a vehicle operator's home or workplace. GNSS module 22 may be used to provide navigation and other position-related services to the vehicle operator. In one embodiment, the GNSS module can be a global positioning satellite (GPS) module that receives location information from a plurality of GPS satellites. Navigation information can be presented on the display 58 (or other display within the vehicle) or can be presented verbally such as is done when supplying turn-by-turn navigation. The navigation services can be provided using a dedicated in-vehicle navigation module (which can be part of GNSS module 22), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The position information can be supplied to remote facility 18 or other remote computer system, such as computer 16, for other purposes, such as fleet management and/or for use in a car sharing service. Also, new or updated map data can be downloaded to the GNSS module 22 from the remote facility 18 via a vehicle telematics unit or wireless communications device 30.

Vehicle electronics 20 also includes a number of vehicle user interfaces that provide vehicle occupants with a means of providing and/or receiving information, including pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Messaging broker 60 can include a variety of computer hardware and software and may comprise of multiple servers and databases that act in a coordinated manner as to connect to client devices, receive messages from client devices, and to send messages to client devices. In a particular embodiment messaging broker includes numerous electronic computing servers that include various network interfaces for establishing connections between one another, as well as for establishing connections with other remote devices, such as vehicle 12, mobile device 14, computers 16, and/or remote servers 82, all of which may be configured as a client device. Messaging broker 60 can be implemented using various messaging software, including libraries that can be downloaded and installed on various electronic computing devices or servers. In one particular embodiment, the broker implements an MQTT protocol and can include an MQTT library that enables the servers to act as a broker. According to the publish-subscribe messaging protocols discussed herein, the client devices can communicate with one another only via sending and receiving messages to and from the messaging broker 60—that is, no direct communications connection is established among client devices. However, some communication systems may use various protocols for network communications and, thus, the client devices may send and receive messages using the publish-subscribe messaging technologies for certain messages, while using other communication protocol and technologies for other messages.

As mentioned above, the publish-subscribe messaging technologies and/or protocols are those in which client devices communicate to one another through publishing messages to a messaging broker, subscribing to certain topics (or types of messages) with the messaging broker, and receiving messages from the messaging broker that correspond to the subscriptions held for that particular client device at the broker. Typically, a client device can publish messages to the broker and the messages can include a “topic” or a “topic name” that identifies a topic. As used herein, the “topic” is a class of messages that can be specified in a message that is being published to the broker. The broker, after having received the message that designates a particular topic, can then send the message to all the client devices that are subscribed to the particular topic.

According to many embodiments discussed herein, Message Queue Telemetry Transport (MQTT) is used as the publish-subscribe messaging protocol. The MQTT may be used at the application layer that may be implemented at the client devices and the messaging broker through use of computer instructions stored on a non-transitory computer-readable medium, such as EEPROM, flash memory, etc. The computer instructions can include one or more libraries, such as an MQTT broker library (for the messaging broker) and an MQTT client library (for the client devices). The MQTT protocol can be used along with TCP/IP, and can include Transport Layer Security (TLS), such as Secure Sockets Layer (SSL) security, as discussed more below. As used herein, for simplicity, SSL refers to both TLS and SSL systems and technologies. In other embodiments, such as those that use MQTT for Sensor Networks (MQTT-SN), other transport and/or security protocols can be used, such as User Datagram Protocol (UDP).

In some embodiments, a third party messaging broker service can be used, such as those offered by Microsoft™ Azure and HiveMQ™. In other embodiments, a messaging broker can be installed on proprietary equipment, such as one or more servers owned and/or operated by a vehicle manufacturer such as an OEM.

As mentioned above, vehicle 12, mobile device 14, computers 16, and/or remote servers 82 all may be configured as client devices that use a publish-subscribe messaging protocol to communicate messages with one another via messaging broker 60. Each of these client devices may include various libraries that enable the device to act as a client device and carry out those operations of a client device using the publish-subscribe messaging protocol. In a particular embodiment, MQTT is used and each client device includes a client library (e.g., an MQTT client library) and the broker includes a broker library (e.g., an MQTT broker library). As used herein, a client library is an electronic library that includes a background codebase that, when properly implemented, can be used to enable the device onto which it is installed to participate as a client device in the publish-subscribe messaging communication system discussed herein. And, as used herein, a broker library is an electronic library that includes a background codebase that, when properly implemented, can be used to enable the device onto which it is installed to participate as a messaging broker in the publish-subscribe messaging communication system discussed herein. In some embodiments, the client library and the broker library may be included in the same library and, thus, based on how the device implements and/or makes us of the library will determine whether the device is acting as a client device or as a messaging broker in the publish-subscribe messaging communication system.

In one embodiment, a messaging broker can be implemented and launched from a single remote location. Or, in other embodiments, a plurality of messaging brokers may be distributed and located at various locations and, in such an embodiment, the brokers may each be interconnected with one another via, for example, use of land network 76 in conjunction with one or more networking protocols, such as TCP/IP and/or User Datagram Protocol (UDP)—other transport and addressing protocols may be used. Additionally, in a particular embodiment, a network of brokers may be connected to one another through use of the publish-subscribe messaging communication—that is, the brokers could act as both a broker and a client device. This dual role may be useful in when numerous brokers are distributed but need to coordinate with one another.

Any and all of the messages sent between the messaging broker and the client device can include a header. The header can indicate a message length and a message type, as well as other information.

As mentioned above, the client devices do not directly connect with one another when using the publish-subscribe messaging protocol; rather, the client devices connect to the messaging broker. A connection can be established through the client device sending a connection request message to the broker. As mentioned above, TCP/IP can be used and the IP address of the messaging broker can correspond to a domain name. The connection request message can be a CONNECT message (as specified in the MQTT specifications) that is configured according to the MQTT protocol. The connection request message can include various information, such as a client identifier, a clean session boolean flag, a keep alive timeout value, a username, a password, and various other information (such as “last will” information).

The client identifier can be selected by the client and, in some embodiments, can be selected as to be unique from other client devices. For example, vehicle 12 can use its vehicle identification number (VIN) as its client identifier when sending a connection request message to the messaging broker. In other embodiments, the vehicle can include various VSM that are configured as client devices in the publish-subscribe messaging system and, thus, these VSMs could use the VIN of the vehicle in which they are housed along with a specific VSM identifier so that the client identifiers are unique to specific VSMs within a particular vehicle. The vehicles and/or other client devices can also utilize other known identifiers, such as media access control (MAC) addresses or universally unique identifiers (UUID).

The connection request message can include a username and/or a password that can be used for authentication purposes as well as for authorization purposes. In the case where usernames/passwords are used, the username and password can be included in the connection request message, which may be encrypted using TLS/SSL. The broker 60 can keep a list of usernames and passwords so that when a username-password pair is received, the messaging broker 60 can verify the pair. If the username-password pair is verified, the broker can send a connection acknowledgement message to the client device, as discussed more below. Additionally, or alternatively, messaging broker 60 can keep an authorized client list that keeps track of a list of client identifiers or usernames of devices that are authorized to use messaging broker 60. And, in some embodiments, the authorized client list can include authorized topics for each client device so that the messaging broker 60 can determine whether a particular client device has authorization to subscribe and/or receive messages concerning a particular topic. In another embodiment, the messaging broker 60 can only permit connections with those client devices that specify a client identifier that matches a client prefix that is stored at the messaging broker. For example, the messaging broker 60 may only permit those devices that include the prefix “VEH” to connect; thus, a client device that sends a connection request message that specifies “123VEH” as a client identifier will not be connected to, while a client device that sends a connection request message that specifies “VEH123” as a client identifier will be connected to. Other string pattern filters can be used, such as suffix filters, contains filters, match filters, etc.

The connection request message can also include certain ungraceful disconnect information. The ungraceful disconnect information can include a topic name, a quality of service level, a message, and a retain flag. When the messaging broker determines that a client device ungracefully disconnected (i.e., without sending a disconnection message) from the messaging broker, then the messaging broker can send the ungraceful disconnect message to the other client devices that are subscribed to the topic specified in the ungraceful disconnect information.

In some embodiments, TLS/SSL can be used so that a secured connection between the messaging broker and the client devices can be established. A TLS/SSL handshake can be carried out when first establishing a connection. An X509 certificate can be used that includes a public encryption key and a signature that can be verified using the public encryption key and the other contents of the X509 certificate. For example, once the certificate is received, the public key can be used to decrypt the signature and, thereafter, the other contents of the certificate can be hashed using a particular hash algorithm (e.g., MD5) (which may be specified in the certificate). The decrypted signature can then be compared to the hash value of the certificate contents (not including the signature) and, if the two match or otherwise correspond, then the certificate can be considered valid. Other authentication techniques known to those skilled in the art can be used as well.

Once the messaging broker receives a connection request message and verifies the message, such as using one or more of the techniques discussed above, the messaging broker can send a connection acknowledgement message to the client device. The connection acknowledgement message can be a CONNACK message (as specified in the MQTT specifications). The connection acknowledgement message can include a session present boolean flag and a return code that indicates whether the connection has been accepted or not and/or the reason the connection was not accepted. Once a connection acknowledgement message is received that includes a return code indicating that the connection has been accepted, then it can be said that a connection between the client device and the messaging broker has been established.

When a client device desires to disconnect from the messaging broker, the client device can send a disconnection message to the messaging broker, such as a DISCONNECT message as specified in the MQTT specification. After the disconnection message is received by the messaging broker, the messaging broker can cease all communications with the disconnected client device at least until a new connection is established.

After a client device, such as vehicle 12, has established a connection with the messaging broker, then the client device can begin to publish messages to the broker. A publish message can include metadata along with a payload that includes the substance of the message that is being published. The metadata can include various fields, such as those that are included in the PUBLISH message, as specified in the MQTT specification. For example, the metadata can include a packet identifier that allows the packet (i.e., message) to be uniquely identified from other messages sent between the client device and the messaging broker. Also, the metadata can include a topic name that specifies a topic to which the message pertains. The topic name can be an identifier that identifies a particular vehicle, such as vehicle 12, or a particular component of the vehicle. Or, the topic name can be an identifier that pertains to one or more particular vehicle functions or one or more vehicle characteristics or states. The metadata can also include a quality of service indicator that indicates a particular quality of service level for the publish message. Quality of service indicators are discussed in more detail below.

Other potential metadata information that can be included in the publish message includes a duplication flag indicating whether the publish message is a duplicative message that was sent and a message retention flag that indicates whether the message should be retained so that it may be sent to other client devices that connect to the messaging broker after the publish message is received. As mentioned above, typically the messaging broker in publish-subscribe messaging protocols deletes the publish messages after they are sent to the then presently connected client devices that are subscribed to the particular topic as specified in the publish message. However, as discussed more below, other embodiments exist, such as those where certain messages are retained—e.g., certain publish-subscribe messaging protocols or implementations include certain mechanisms that enable the retention of publish messages, such as through setting a message retention flag in the publish message.

In response to receiving the publish message from the client device, the messaging broker can send a publish acknowledgement message, such as the PUBACK message as specified in the MQTT specification. The publish acknowledgement message can include a packet identifier that is the same as the packet identifier from the publish message that the publish acknowledgment message is acknowledging.

Other messages can be sent by the messaging broker to the client device or by the client device to the broker in response to receiving a publish message (or subsequent messages), such as a publish received message (PUBREC as specified in the MQTT specification), a publish release message (PUBREL as specified in the MQTT specification), and a publish complete message (PUBCOMP as specified in the MQTT specification). In one embodiment, these other response messages can be sent when the quality of service level as specified in the publish message is set to a particular level, such as level 2 (which corresponds to delivering one and only one copy of the message to each subscribed client device).

Once a client device has established a connection with the messaging broker, the client device can subscribe to one or more topics. And, as discussed more below, upon establishing a connection with the messaging broker, the client device may already be subscribed to certain topics based on communications carried out during a previous connection. The client device can send a subscribe message that includes subscription requests and metadata. The subscription requests can be in the form of topic name/quality of service indicator pairs, or may simply include a list of topic names to which the client device would like to subscribe to. The metadata can include a packet identifier, such as those discussed above with respect to the publish message.

Once the messaging broker receives the subscription request message, the messaging broker can then save the subscription information for the client device, for example, in a text file that is stored at the messaging broker. In some embodiments, the messaging broker can also verify whether the client device that sent the subscription request message has the proper authorization to receive messages for the topics that it has requested a subscription. In other embodiments, the messaging broker may authorize the client device upon connection establishment and, when subscription requests are received, the messaging broker can automatically honor the requests.

In response to the subscription request message, the messaging broker can send a subscription acknowledgement message, such as a SUBACK message as specified in the MQTT specification. The subscription acknowledgement message can include a packet identifier that matches or corresponds to the packet identifier as the packet identifier in the subscription request message. Additionally, the subscription acknowledgement message can include a return code that indicates whether the subscription was successfully received and processed. In one embodiment, the subscription acknowledgement message can include a return code for each topic name/quality of service pair (i.e., each subscription request) that was included in the subscription request message. And, in a particular embodiment, the return codes can be used to confirm information in the subscription request message, such as a quality of service level that was actually granted by the messaging broker.

In addition to subscribing, a client device may also be able to unsubscribe as well, such as through sending an unsubscribe request message. The unsubscribe request message can be used to inform the messaging broker that the client device desires to unsubscribe from one or more topics that the client device is subscribed to (or that the client device believes that it is subscribed to). The unsubscribe request message can be an UNSUBSCRIBE message as specified in the MQTT specification. The unsubscribe request message can include a packet identifier and one or more topic names of which the client device would like to not hold a subscription. In response to receiving the unsubscribe request message, the messaging broker can then send an unsubscribe acknowledgement message, such as an UNSUBACK message as specified in the MQTT specification. This unsubscribe acknowledgement message can include the packet identifier that was included in the unsubscribe request message so that the client can coordinate the received unsubscribe acknowledgement message with a previously sent unsubscribe request message.

As mentioned above, a quality of service (QoS) level can be specified for topic subscriptions and published messages. Generally, quality of service levels can be used to indicate the importance of the delivery of a message to a client device. As specified in the MQTT specification, there are three quality of service levels: 0 represents that the message will be delivered at most once, but does not guarantee a delivery of the message; 1 represents that the message will be delivered at least once; and 2 represents that the message will be delivered once and only once. In some embodiments, when the client device publishes (or sends) a publish message to the messaging broker with a quality of service level of 0, the messaging broker may forgo sending a publish acknowledgement message.

And, in some embodiments, when the when the client device publishes (i.e., sends) a publish message to the messaging broker with a quality of service level of 2, the messaging broker may send a publish received message (PUBREC). And, then, in response to receiving the publish received message (PUBREC), the client device can send a publish release message (PUBREL). And, finally, in response thereto the messaging broker can send a publish complete message (PUBCOMP) to the client device. Any or all of these messages can include the packet identifier that was included in the initial publish message.

In many embodiments, the publish-subscribe messaging protocol may not generally keep sessions so that a client device must re-subscribe every time a new connection is formed. However, publish-subscribe messaging protocol may include one or more mechanisms that can be used to keep subscription information upon disconnection from a client device so that the client device does not have to re-subscribe at the beginning of the next connection. In one embodiment, a client device may set a clean session flag to false in a connection request message. Thus, this will indicate to the messaging broker to keep subscription information for the client (as specified in the client identifier) at least until a new connection request message is received with the clean session flag set to true. If, after receiving the connection request message with a clean session flag set to false, the messaging broker determines that a session already exists for the client device (as specified in the client identifier), then the messaging broker can indicate this to the client device by including a session present flag set to true in the connection acknowledgement message. Also, when there is a present session for a client device that is subscribed to a particular topic, the messaging broker can retain those messages corresponding to the topic(s) that the client device is subscribed to so that the messaging broker can send these messages to the client device upon reconnection.

Generally, the publish-subscribe messaging protocol may cause the messaging broker and client device to disconnect (or treat the connection as terminated) when no messages have been sent or received between the messaging broker and the client device. As mentioned above, a keep alive value can be included in the connection request message and this value can be used to specify the amount of time in which no messages are communicated between the client device and the messaging broker before the connection is treated as terminated. To keep a session alive, a client device can send a ping request message and, in response thereto, the messaging broker can respond with a ping response message to indicate that the ping request message was received.

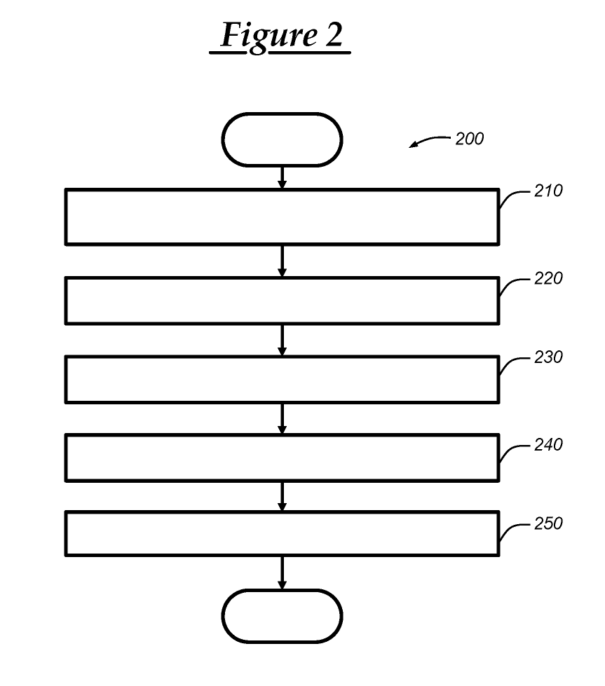

With reference to FIG. 2, there is shown a method 200 of communicating with a vehicle through use of a subscriber-push messaging protocol. Method 200 will be described with vehicle 12, mobile device 14, and remote server 82 as client devices. Method 200 begins with step 210, wherein the vehicle 12 and the messaging broker 60 establish a connection. In one embodiment, a connection to the messaging broker 60 may be established when the vehicle ignition is turned on. The connection request message can be sent using cellular chipset 34 and using cellular carrier system 70 and land network 76. As mentioned above, the vehicle 12 can send a connection request message that includes a client identifier that can be derived from one or more identifiers at the vehicle, such as the vehicle identification number (VIN) of vehicle 12.

In other embodiments, the vehicle may desire to have connections for various system modules (VSMs) within the vehicle. In such embodiments, the client identifier included in the connection request message (and subsequent messages) can include a unique vehicle identifier (e.g., VIN), as well as an identifier of a particular vehicle system module (VSM) that is included in the vehicle.

The connection request message can include various topics or topic names to which the vehicle 12 would like to subscribe to. In one embodiment, the vehicle 12 can subscribe to a vehicle backend services topic, wherein the vehicle backend services topic relates to topics published for the vehicle from a vehicle backend services facility. The vehicle backend services topic can be a topic specified for the particular vehicle or for a particular type of vehicle. The vehicle backend services can include those services that are usually provided via a remote backend server, such as those provided by remote facility 18.

In response to the messaging broker 60 receiving the connection request message, the messaging broker can authenticate and/or verify authorization of vehicle 12 (or the VSM) by any or all of the authentication/authorization mechanisms discussed above. For example, the connection request message can include a username and a password and, after receiving the connection request message, the messaging broker 60 can recall a username-password file from memory and determine whether the username and password match. Moreover, the messaging broker 60 can include a list of authorized devices, which may be specified by a username, password, client identifier, or any combination thereof. Alternatively or additionally, the messaging broker 60 can include an unauthorized client list that can be used to verify whether the requesting client device is unauthorized for a connection or for subscription to particular topics.

In response to the connection request message, the messaging broker 60 can send a connection acknowledgement message that can include a return code. The return code can indicate to vehicle 12 (or VSMs therein) whether the messaging broker 60 decided to accept or refuse the connection. The method 200 continues to step 220.

In step 220, the vehicle can obtain information regarding the vehicle state. The obtained information can then be packaged into the payload of a publish message, such as a PUBLISH message according to the MQTT protocol, which can then be published to the messaging broker (see step 230). In one embodiment, information concerning one or more states of the vehicle, vehicle system modules (VSMs), an operator or user of the vehicle, a passenger of the vehicle, or the environment surrounding the vehicle can be obtained. For example, the vehicle information can be the vehicle's location (which can be determined using GNSS module 22), ignition status, speed, velocity, acceleration, diagnostic codes (including diagnostic test codes (DTCs)), passenger/driver statuses, fuel level, battery level, and various other vehicle information. Or, other information can be obtained by the vehicle, such as information concerning one or more passengers or operators and/or environmental information. Information regarding the one or more passengers or operators can include the presence of such individuals in or at the vehicle, the presence of one or more mobile devices carried by the individuals in or at the vehicle, and/or one or more health states or conditions of the individuals. Environmental information can include a presence temperature inside or outside the vehicle, the weather or predicted weather as observed by the vehicle (e.g., through use of barometers, or rain gauges), wind speed, humidity, and various other environmental information that can be gathered or obtained at the vehicle through use of one or more vehicle system modules. In one embodiment, the obtained information can include any or all information that was obtained through use of a vehicle sensor installed in the vehicle. This information can be obtained using various VSMs, such as through use of a body control module (BCM) located on the vehicle, ECU 24, GNSS module 22, wireless communications device 30, microphone 56, pushbutton 52, or any other VSM 42.

In one embodiment, information can be gathered and/or obtained by the vehicle in response to the vehicle determining that another client device, such as remote facility 18 or mobile device 14, desires to obtain vehicle information. For example, the vehicle may receive a message from another client device (as in step 240, which, in some embodiments, can be carried out after step 210 and before steps 220 to 230) to which a response from the vehicle is desirable or expected. In one embodiment, a user may use mobile device 14 to send a vehicle command to the vehicle through use of messaging broker 60 and, in response to the vehicle receiving and/or processing the command, the vehicle can then obtain information as to whether the command was actually carried out and a vehicle state associated with the vehicle command. For example, upon receiving an ignition start command, the vehicle can start the ignition, and then gather information as to the vehicle's engine, such as the revolutions per minute (RPM) or the engine temperature, which can then be reported back to the mobile device 14 via the messaging broker 60 (see step 230). The method 200 continues to step 230.

In step 230, the vehicle publishes or sends a publish message to the messaging broker. In one embodiment, the payload of the publish message includes information pertaining to the present state of the vehicle, such as the vehicle information obtained in step 220. For example, when the vehicle desires to send information pertaining to its ignition system, the vehicle can generate a publish message that includes a topic name of “ignition.” In other embodiments, the vehicle can include its VIN or other identifier in the topic name, along with a VSM identifier or another identifier of a certain vehicle subsystem, module, attribute, or characteristic. In some embodiments, the payload of the publish message can be separately encrypted using a first encryption key. The client device to which the message is intended can include a second encryption key that corresponds to the first encryption key. For example, the first and second encryption key can be the same key as used in a symmetric key encryption scheme or one may be a public key and the other may be a private key according to a public key infrastructure.

The publish message can be sent using cellular chipset 34 or SRWC circuit of device 30 to messaging broker 60 via cellular carrier system 70 and/or land network 76. And, in response to receiving the publish message from the client device, the messaging broker 60 can carry out various steps, such as those discussed above. For example, the messaging broker 60 can send a publish acknowledgement message to vehicle 12 in response to receiving the publish message.

Additionally, once the messaging broker 60 receives the published message from vehicle 12 and processes the publish message, the messaging broker 60 can recall from memory those client devices that are subscribed to the topic of which was specified in the publish message. Once the message is sent to all of the subscribed client devices, the message may be deleted. However, in some embodiments, the publish message can include a message retention flag that can indicate whether the message should be retained until all subscribed client devices are connected so that they may receive the message. The method 200 continues to step 240.

In step 240, the vehicle may receive a message from the messaging broker. In one embodiment, the messaging broker 60 can send a message to the vehicle 12 in response to the messaging broker 60 receiving a publish message from another client device. For example, a user may use mobile device 14 to request a vehicle function be carried out. In such a scenario, an application 15 on mobile device 14 can generate a publish message that is sent to the messaging broker 60 and that includes a topic name that includes information pertaining to vehicle 12, such as a topic name that begins with the VIN of vehicle 12.

The message can be delivered to the vehicle via land network 76 and/or cellular carrier system 70. The message can include various information that can be used by the vehicle, such as a command that was sent from a mobile device, wherein the command indicates a vehicle function to be carried out. Or, the message may include a software update for a vehicle module (or part thereof). The method 200 continues to step 250.

In step 250, the vehicle disconnects from the messaging broker. In one embodiment, this can be carried out through sending a disconnection message from the vehicle to the messaging broker, such as a DISCONNECT message as specified in the MQTT protocol. In another embodiment, this can occur automatically through an absence of use of the publish-subscribe messaging connection between the vehicle and the messaging broker (i.e., a timeout) for a time exceeding the keep alive value as specified in the connection request message or a default keep alive time (e.g., as specified by the messaging broker or by the publish-subscribe messaging libraries). In other embodiments, the disconnection may be carried out through the vehicle sending a disconnection message to the messaging broker.

In a particular embodiment, as discussed above, the vehicle may include various client devices. For example, each of the one or more VSMs at the vehicle, including the wireless communications device 30, GNSS module 22, ECU 24, and other VSMs 42 can be a client device with a separate connection to the messaging broker 60. Or, in another embodiment, the wireless communications device 30 can be a client device for use with messaging broker 60 and the wireless communications device 30 can act as a gateway between the publish-subscribe protocol and all or some of the other VSMs of vehicle 12. In this way, the wireless device 30 can publish and receive messages, but can do so in a way such that it can determine which VSM of vehicle 12 a message is to be received by or to be addressed from. Thus, only a single connection with the messaging broker 60 is used for many VSMs of vehicle 12. In these embodiments, any or all of the publish-subscribe messaging connections can be terminated by sending a disconnection from the client device to the messaging broker. In response to receiving the disconnection message, the messaging broker 60 can generate and send a disconnection acknowledgement message back to the client device thereby informing the client device that the connection has been terminated or disconnected. The method 200 then ends.

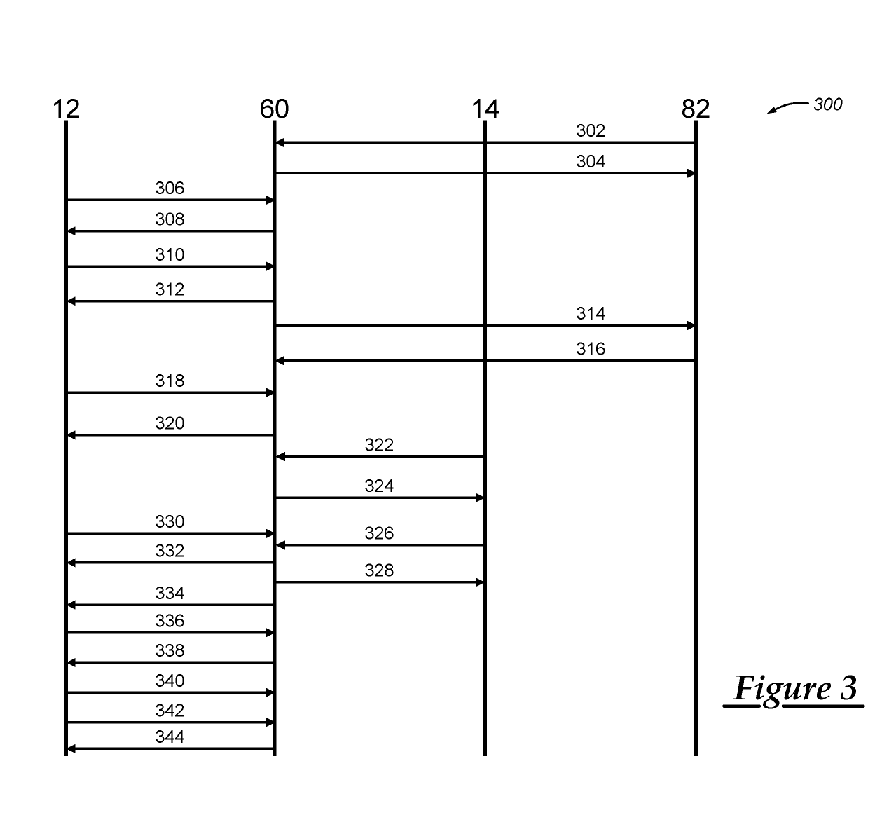

With reference to FIG. 3, there is shown a diagram depicting a potential scenario 300 that can occur through implementation of at least one embodiment of the method discussed herein. In step 302, the remote server 82 can send a connection request message to the messaging broker 60 in an attempt to establish a connection using the publish-subscribe messaging protocol. The connection request message can include certain topics to which the remote server 82 desires to subscribe to, such as topics pertaining to particular vehicles or a particular class, type, or group of vehicles. In one embodiment, the topic name can include a VIN of vehicle 12, such as “1GNSKJKCZGR9999EX,” or can include a VIN with wildcard characters such that the topic name captures all VINs of a particular type. For instance, the uniquely identifying serial numbers of a vehicle (i.e., the last six digits) may be removed and replaced with a wildcard character such as “*”—e.g., “1GNSKJKCZGR*” will include all VINs that begin with “1GNSKJKCZGR”, as the “*” indicates that any zero or more characters may be appended to “1GNSKJKCZGR” and still match.

Before step 304 and after the connection request message is received by the messaging broker 60, the messaging broker can authenticate and/or determine the authorization of the remote server 82 through use, for example, of a username/password included in the connection request message. In other embodiments, the payload of the connection request message can include authentication information, such as an X509 certificate and/or authorization information, including entitlement information (i.e., data that carries information sufficient to indicate an entitlement or authorization to perform some function) that indicates to the messaging broker (or to the vehicle or other client device) of whether the remote server 82 has been trusted to establish a connection. In step 304, the messaging broker can send a connection acknowledgement message that includes, for example, a return code indicating as to whether the connection has been successfully established and/or a quality of service level associated with the connection.

In steps 306 and 308, vehicle 12 establishes a connection with the messaging broker 60. This can be carried out in an analogous fashion to the connection establishment of remote server 82 and messaging broker 60 in steps 302 and 304. In step 306, the vehicle can include certain topic names that it desires to subscribe to. In addition, the vehicle can include a username/password pair in the connection request message, or may include other credentials, authentication information, or entitlement information in the payload of the connection request message. In one embodiment, the connection request message can include the VIN of the vehicle, another identifier of the vehicle or a vehicle system module, a version of software installed in the vehicle, or an identifier of the remote server 82. And, in one embodiment, before sending a connection request message, an SSL handshake between the messaging broker and the client device can be carried out. After a connection request message is received by messaging broker 60, the messaging broker 60 can generate and send a connection acknowledgement message to vehicle 12.

In step 310, the vehicle can generate and send a publish message to the messaging broker 60, such as a publish message as described above in step 230 of method 200 (FIG. 2). The publish message can include a topic name that corresponds or includes the VIN of the vehicle. In step 312, in response to receiving the publish message, the messaging broker 60 can verify the message and then send a publish message acknowledgment message back to vehicle 12.

In step 314, the messaging broker can send the publish message (or contents thereof) to all client devices that are subscribed to the topic name that was included in the publish message. For example, the remote server 82 can subscribe to a topic name corresponding to the VIN of the vehicle and, thus, when the messaging broker 60 receives a publish message with a topic name corresponding to the VIN, the messaging broker can then send the message to the remote server 82. The publish message sent to the broker from vehicle 12 in step 310 can be the same message as sent from the messaging broker 60 to the remote server 82 in step 314 or, the message sent in step 314 may be a different message with certain information derived from the publish message sent in step 310. In step 316, the remote server 82 can send a publish message acknowledgement message to the messaging broker indicating that the publish message has been received from the broker.

In step 318, the vehicle sends a ping message to the messaging broker 60 as to keep the connection alive. As mentioned above, the connection may timeout and, thus, become disconnected such that a new connection would need to be established before any further communications between the vehicle and messaging broker could be carried out. In response to receiving the ping request message, the messaging broker 60 can send a ping response message that acknowledges that the ping request message was received at the messaging broker 60, as shown in step 320.

In step 322, the mobile device 14 can send a connection request message to the messaging broker 60. The connection request message can include various information and/or topic names to which the client desires a subscription. In one scenario, the mobile device 14 can subscribe to the vehicle 12 or a topic associated with vehicle 12 or VSMs of vehicle 12. In step 324, a connection acknowledgement message is sent from the messaging broker 60 to the mobile device 14 in response to the messaging broker 60 receiving and verifying the connection request message.

In step 326, the mobile device 14 can publish a message to the messaging broker 60 and, in one embodiment, the message can include a topic name or other information that indicates that a message should be sent to the vehicle in a timely manner. In one embodiment, the mobile device can include a vehicle command in the publish message of step 326. In step 328, the messaging broker sends a publish acknowledgement message to the mobile device. In step 330, the vehicle can send another ping message as to continue keeping the connection alive and, in response, the messaging broker 60 can send a ping response to vehicle 12, as shown in step 332.

In one scenario, the messaging broker 60 may determine that a message should be sent to the vehicle in a timely manner and, thus, may determine if a present connection to the targeted vehicle is established. For example, if the publish message received from the mobile device in step 326 indicates that the message should be delivered soon or in the near future, then the messaging broker 60 can send a wake up message to vehicle 12 which indicates to the vehicle that the vehicle should operate in an active mode as to allow publish messages (i.e., messages that typically contain a payload conveying a particular message) to be received, as shown in step 334. As used herein, “waking up” can include transitioning from operating the wireless communications device 30 in a low power mode to operating the wireless communications device 30 in a normal operating mode, which can include supplying more power to the wireless communications device. The vehicle 12 can receive this wake up message and, in response, can generate and send a response message (step 336).

Thereafter, the messaging broker 60 can send the publish message from step 326 to vehicle 12 over the established connection, as shown at step 338. And, in step 340, the vehicle 12 can then send a publish acknowledgement message. Once the vehicle receives and processes the publish message, including checking entitlement or authentication information, the vehicle can carry out the command. Additional messages may be published to the messaging broker 60 from vehicle 12 and from the messaging broker 60 to mobile device 14, so as to indicate that the vehicle command has or has not been carried out.

In step 342, vehicle 12 sends a disconnect message to the messaging broker 60 indicating that the vehicle desires to disconnect. In response to receiving the disconnect message from the vehicle 12, in step 344, the messaging broker 60 can send a disconnection acknowledgement message to the vehicle 12 indicating that the disconnection message has been received and/or the connection has been terminated. In other embodiments, the vehicle 12—remote server 82 connection may be disconnected automatically from a timeout of the connection (i.e., inactivity in the connection for a certain amount of time, for example, as specified in the connection request message). The scenario 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of communicating with a vehicle through use of a publish-subscribe messaging protocol, wherein the vehicle includes a wireless communications device that is capable of carrying out data communications with a remote server or system through use of a messaging broker according to the publish-subscribe messaging protocol, the method comprising:
establishing at least one connection with a messaging broker using the wireless communications device, wherein the connection is established using the publish-subscribe messaging protocol, and wherein each of the at least one connection is established by sending a connection request message from the vehicle to the messaging broker;
obtaining vehicle information from at least one vehicle system module (VSM) of the vehicle;
generating a publish message at the vehicle, wherein the publish message includes the obtained vehicle information; and
sending the publish message from the vehicle to the messaging broker using the publish-subscribe messaging protocol.

2. The method of claim 1, wherein the establishing step further comprises, after sending the connection request message, receiving a connection acknowledgement message from the messaging broker, wherein the connection acknowledgement message indicates that the established connection is successful.

3. The method of claim 1, wherein the connection request message includes one or more topic names of topics to which the vehicle or a vehicle system module, including the at least one VSM, is requesting a subscription.

4. The method of claim 3, further comprising the step of receiving a second publish message from the messaging broker, wherein at least some of the data included in the second publish message is at least partly based on information included in a third publish message that was received by the messaging broker from a client device.

5. The method of claim 4, wherein the client device is a mobile device and wherein the at least some of the data included in the second publish message includes a vehicle command.

6. The method of claim 5, wherein the third publish message includes a quality of service indicator that guarantees delivery of the second publish message at least once.

7. The method of claim 5, wherein the messaging broker is configured to:
in response to receiving the third publish message at the messaging broker from the mobile device, determine whether the third publish message specifies a topic name of a topic to which the vehicle holds a subscription;
when it is determined that the third publish message specifies a topic name of a topic to which the vehicle holds a subscription, determine whether the vehicle is presently connected to the messaging broker via the established connection; and
when it is determined that the vehicle is not presently connected to the messaging broker via the established connection, sending a wake up message to the vehicle.

8. The method of claim 7, wherein the wake up message is received at the vehicle using a data messaging protocol other than the publish-subscribe messaging protocol and wherein the method further comprises: in response to receiving the wake up message from the message broker, re-establishing the connection with the messaging broker so as to allow the second publish message to be received at the vehicle.

9. The method of claim 1, wherein the vehicle includes a plurality of vehicle system modules (VSMs) and wherein the at least one connection includes a connection for each of the plurality of VSMs, and wherein each of the plurality of VSMs establish the connection with the messaging broker using the wireless communications device included in the vehicle.

10. The method of claim 9, wherein each of the connection request messages includes a client identifier that is based on or derived from an identification number of the vehicle and wherein each of the client identifiers are unique from one another.

11. The method of claim 1, wherein the publish message includes a topic name, and wherein the messaging broker is configured to send at least part of the publish message to one or more client devices that are subscribed to the topic name in response to receiving the publish message.

12. The method of claim 1, wherein the connection establishment step further includes carrying out a Secure Sockets Layer (SSL) handshake with the messaging broker.

13. A method of communicating with a vehicle through use of a publish-subscribe messaging protocol, wherein the vehicle includes a wireless communications device that is capable of carrying out data communications with a remote server or system through use of a messaging broker according to the publish-subscribe messaging protocol, the method comprising:
establishing a connection with a messaging broker using the wireless communications device, wherein the connection is established using a publish-subscribe messaging protocol, and wherein the connection is established by:
sending a connection request message from the vehicle to the messaging broker; and
after sending the connection request message, receiving a connection acknowledgement message from the messaging broker, wherein the connection acknowledgement message indicates that the established connection is successful;
obtaining vehicle information from one or more vehicle system modules (VSMs) of the vehicle;
generating a publish message at the vehicle, wherein the publish message comprises metadata and a payload that includes the obtained vehicle information, and wherein the metadata includes a topic name corresponding to the vehicle and/or the obtained vehicle information;
sending the publish message from the vehicle to the messaging broker using the publish-subscribe messaging protocol, wherein the messaging broker is configured to send at least part of the publish message to one or more client devices that are subscribed to the topic name that was included in the publish message; and
after sending the publish message, receiving a publish acknowledgement message from the messaging broker.

14. A vehicle communications system, comprising:
a vehicle backend services facility that comprises:
one or more servers that each include a processing device and a memory device; and
one or more databases that includes vehicle information; and
a vehicle comprising:
a wireless communications device including a processing device, a memory device, and wireless communications circuitry;
a plurality of vehicle system modules (VSMs); and
a communications bus that connects the wireless communications device with the plurality of VSMs;
wherein the wireless communications device is configured to:
receive a first set of messages from the plurality of VSMs using the communications bus; and
send a second set of messages to a messaging broker according to a publish-subscribe messaging protocol using the wireless communications circuitry, wherein the second set of messages are based at least partly on the first set of messages; and
wherein the messaging broker is configured to:
receive the second set of messages from the vehicle;
determine whether the vehicle backend services facility is subscribed to a topic name included in the second set of messages; and
when it is determined that the vehicle backend services facility is subscribed to a topic name included in the second set of messages, send a third set of messages to the vehicle backend services, wherein the third set of messages includes vehicle information contained in the second set of messages; and
wherein the vehicle backend services facility includes computer instructions included on the memory device that, when executed, cause the processing device to:
receive the third set of messages from the messaging broker according to the publish-subscribe messaging protocol;
extract the vehicle information contained in the payload of third set of messages; and
store the vehicle information into the one or more databases.

15. The vehicle communications system of claim 14, wherein the wireless communications circuitry includes a cellular chipset that is capable of carrying out communications with a cellular carrier system.

16. The vehicle communications system of claim 15, wherein the second set of messages and the third set of messages are the same.

17. The vehicle communications system of claim 15, wherein the wireless communications device is configured to establish a connection with the messaging broker according to the publish-subscribe messaging protocol and through carrying out a Secure Sockets Layer (SSL) handshake, and wherein communications between the wireless communications device and the messaging broker are carried out using Transport Control Protocol/Internet Protocol (TCP/IP) along with SSL encryption.

18. The vehicle communications system of claim 17, wherein the vehicle communications system further comprises the messaging broker.

19. The vehicle communications system of claim 18, wherein the second set of messages includes a payload, wherein the wireless communications device is further configured to encrypt the payload of the second set of messages using a first encryption key, wherein the third set of messages includes the encrypted payload of the second set of messages, and wherein the vehicle backend services facility includes a second encryption key that corresponds to the first encryption key according to a common encryption key so that the vehicle backend services facility can decrypt the encrypted payload of the third set of messages that are received from the messaging broker.

20. The vehicle communications system of claim 19, wherein the publish-subscribe messaging protocol is Message Queue Telemetry Transport.
